(19) United States
(12) Patent Application Publication
(10) Pub. No.: US 2019/0200525 A1
(43) Pub. Date: Jul. 4, 2019

(54) Retractable hollow finger for harvesting header

(71) Applicant: MacDon Industries Ltd., Winnipeg (CA)

(72) Inventors: Myles Bruce MacMillan, Winnipeg (CA); John Edward Enns, East St. Paul (CA); Kenneth Ross Parson, Winnipeg (CA)

(21) Appl. No.: 15/858,539

(22) Filed: Dec. 29, 2017

(51) Int. Cl. A01D 61/00; A01D 41/12; A01D 57/01

(52) U.S. Cl. CPC A01D 61/006; A01D 57/01; A01D 41/12; A01D 61/008

(57) ABSTRACT

A crop feeding apparatus having a roller through which the fingers are extended and retracted, has fingers that are formed with tubular finger bodies extending between an inner end configured to be mounted on a finger drive arrangement of the crop feeding apparatus and an outer end of the finger body configured to protrude from the outer peripheral wall of the roller. A breakaway region is formed in the finger body by diametrically opposed slots which are circumferentially elongated to define a shear plane perpendicular to the long axis of the finger body. A slot axis extending between opposing ends of each slot is parallel to the axis of the crop feeding apparatus. The finger body is also hardened by heat treating, and by applying a wear resistant coating over the heat treated body.

This invention relates to a feed roller of the type having generally radially extending fingers which move relative to the roller axis so that their length extending from the roller surface changes around the roller axis for engaging into and for releasing the crop.

### BACKGROUND OF THE INVENTION

Feed rollers are commonly used in crop harvesting machines for guiding the crop from a position in front of the roller to a position rearwardly of the roller. Such rollers are used in many different locations in crop feeding systems and the arrangement described herein is not limited to any particular location of such a crop feeding roller.

However, one primary use of such rollers is in that of guiding the crop from a harvesting header into the feeder house of a combine harvester. Such headers can be of the type which simply provide a cutter bar across the front of the header using any suitable cutting technique behind which is located the guide roller which includes an auger flight for transporting the crop material inwardly from the width of the cutter bar to the narrower width of the feeder house.

Other arrangements include a draper system so that the crop is transported primarily from the width of the cutter bar inwardly to the narrow width of the feeder house using one or more side drapers which carry the crop to a central feed draper which moves rearwardly toward the feeder house. Arrangements of this type are manufactured by a number of manufactures but primarily by the assignee herein. In the draper header system, the feed roller is therefore much narrower since it is only intended to guide the material into the feeder house rather than the transport the material wholly along the length of the header. In many cases therefore the roller is also of smaller diameter.

In all of these arrangements, the roller generally includes a series of angularly and axially spaced fingers which project through the peripheral wall forming the roller and outwardly from the outer peripheral surface of the roller so as to engage the crop.

The fingers are driven so that they move longitudinally so as to increase and decrease their extension from the peripheral wall of the roller. Their maximum extension from the peripheral surface of the roller is located at the location where the fingers are intended to engage and grasp the crop and the minimum extent is located at the position where the fingers are intended to release the crop. Thus, the fingers generally are at their maximum extent at a position forwardly of the roller and the fingers rotate with the roller around the underneath of the roller and are retracted as they move behind the roller to allow the crop to be released to enter into the feeder house to be engaged by the feeder chain of the feeder house. At the position rearward of the roller, the fingers are retracted by the position of the finger rotation axis to locations substantially close to or flush with the surface of the roller to release the crop.

This arrangement is well established, widely used and has been widely successful. Arrangements of this type are shown in U.S. Pat. No. 7,392,646 (Patterson) issued Jul. 1, 2008 assigned to the present assignees, the disclosure of which is incorporated herein by reference.

In the event of any jamming of the end of the finger, for example against incompressible debris that may be collected by the header (driftwood, rocks, stumps, etc.), the finger may be bent and no longer align with respective finger guide holes in the peripheral wall of the roller. This typically results in further damage to the peripheral wall and to the finger drive assembly by the continued extension and retraction of the bent finger. To avoid excessive damage to the roller, various attempts have been made to form a breakaway region where the finger has been weakened by a ring groove for example to encourage breakage of the finger when debris is encountered instead of bending the finger.

As described in U.S. Pat. No. 7,937,921 by AGCO Corporation, it is known in the art to make such fingers out of a light, tubular steel alloy that is intended to break in the event of untoward loading on the finger such as when striking a rock or other obstruction in the field. However, such tubular fingers tend to break at random locations along their length, or simply bend instead of break off completely and cleanly. Either of such conditions can result in serious damage to the auger tube or the operating mechanism within the auger tube. Although attempts are made to ensure breakage at a desired location that minimizes damage to the roller, the performance of the breakaway region in a lightweight tubular finger can be affected by wear on the finger. More particularly, the resulting wear on known tubular fingers for a feed roller as the fingers are extended and retracted relative to the peripheral wall of the roller can introduce additional points of weakness at undesirable locations along the length of the finger which results in undesirable bending when debris is encountered instead of clean breakage of the finger at a desired location which minimizes damage to the roller.

### SUMMARY OF THE INVENTION

According to one aspect of the present invention there is provided a retractable finger for a crop feeding apparatus having a rotatable roller, a plurality of finger guide holes in an outer peripheral wall of the roller and a finger drive arrangement supported within the roller to support the finger thereon and drive the finger as the roller rotates about a longitudinal axis of the roller to be movable along a length of the finger from an extended position in which the finger protrudes from the peripheral wall of the roller and a retracted position in which the finger is retracted inwardly of the outer peripheral wall relative to the extended position, the retractable finger comprising:

a finger body extending along a longitudinal axis between an inner end of the finger body configured to be mounted on the finger drive arrangement and an outer end of the finger body configured to protrude from the outer peripheral wall of the roller through a respective one of the finger guide holes in the extended position; and

a breakaway region formed in the finger body in proximity to the inner end at an intermediate location between the inner end and the outer end of the finger body;

the finger body comprising a cylindrical outer wall surrounding a hollow interior, spanning a length of the finger body between the inner end and the outer end thereof; and

the breakaway region comprising a pair of slots formed in the cylindrical outer wall of the finger body at diametrically opposing locations relative to one another, each slot being elongated in a circumferential direction about the finger body.

The design of the breakaway region to be formed of slots that are elongated in the circumferential direction ensures breakage at the desired location within a respective shear plane defined by the slots in a more reliable manner than many prior art designs for a breakaway region in a hollow retractable finger.

Preferably each slot is oriented such that an imaginary line connected between circumferentially opposing ends of the slot lies parallel to said imaginary line of the other slot. The imaginary line of each slot preferably lies parallel to the longitudinal axis of the roller.

Preferably the slots lie in a common plane oriented perpendicularly to the longitudinal axis of the finger body.

Each slot preferably extends fully through the cylindrical outer wall such that each slot defines an opening through the cylindrical outer wall which is elongated in the circumferential direction about the finger body.

The finger may be further provided with a wear-resistant coating applied to an outer surface of the cylindrical outer wall in which the finger body is formed of a first material comprising a rigid metal and the wear-resistant coating is formed of a second material having a hardness which is greater than a hardness of the first material.

The finger body with the coating thereon may have a hardness of 55 to 75 HRC.

The coating may span over the breakaway region in some embodiments, however, in other embodiments, the coating may extend over only a working range of the finger between the breakaway region and the outer end of finger which passes through the outer peripheral wall of the roller.

Preferably the finger body underlying the coating has a hardness of 35 to 65 HRC. The finger body underlying the coating may comprise steel which has been heat treated to achieve the preferred hardness of 35 to 65 HRC.

According to another important independent aspect of the present invention, an outer surface of the cylindrical outer wall may have an arithmetical mean roughness in a range of 40 to 120 Ra before application of the coating. Preferably the coating is applied in a sufficiently thin layer to preserve the mean roughness on the resulting outer surface of the coating. The surface roughness minimizes the contact area between the finger and the surrounding finger guide bushing in the outer wall of the roller as the finger is reciprocated therethrough so as to reduce the overall amount of friction and build-up of heat on the finger guide bushings. In this manner, the fingers can be reciprocated at a higher rate of speed while minimizing high-heat related wear on the finger guide bushings that might otherwise result from excessive frictional heat build-up between the fingers and bushings.

A radial thickness of the cylindrical outer wall is preferably between an outer surface and the hollow interior of the finger body is in a range of 0.040 to 0.120 inches, with a diameter of the cylindrical outer wall of the finger body preferably being in a range of 0.50 to 0.875 inches.

According to another aspect of the present invention there is provided a method of forming a retractable finger for a crop feeding apparatus having a rotatable roller, a plurality of finger guide holes in an outer peripheral wall of the roller and a finger drive arrangement supported within the roller to support the finger thereon and drive the finger as the roller rotates about a longitudinal axis of the roller to be movable along a length of the finger from an extended position in which the finger protrudes from the peripheral wall of the roller and a retracted position in which the finger is retracted inwardly of the outer peripheral wall relative to the extended position, the method comprising:

providing a tubular finger body formed of a cylindrical outer wall surrounding a hollow interior, spanning a length of the finger body between an inner end of the finger body configured to be mounted on the finger drive arrangement and an outer end of the finger body configured to protrude from the outer peripheral wall of the roller through a respective one of the finger guide holes in the extended position; and

applying a wear-resistant coating to an outer surface of the cylindrical outer wall, the finger body being formed of a first material comprising a rigid metal and the wear-resistant coating being formed of a second material having a hardness which is greater than a hardness of the first material.

Preferably the outer surface of the cylindrical outer wall is finished to result in an arithmetical mean roughness of 40 to 120 Ra, and more preferably an arithmetical mean roughness of approximately 60 Ra.

The method may include hardening the first material of the finger body by heat treating such that the finger body has a hardness of 35 to 65 HRC, and more preferably to a hardness of approximately 50 HRC, prior to application of the coating.

The coating may be applied such that the coating has a hardness of 55 to 75 HRC, and more preferably a hardness of approximately 65 HRC.

According to a further aspect of the present invention there is provided a retractable finger for a crop feeding apparatus having a rotatable roller, a plurality of finger guide holes in an outer peripheral wall of the roller and a finger drive arrangement supported within the roller to support the finger thereon and drive the finger as the roller rotates about a longitudinal axis of the roller to be movable along a length of the finger from an extended position in which the finger protrudes from the peripheral wall of the roller and a retracted position in which the finger is retracted inwardly of the outer peripheral wall relative to the extended position, the retractable finger comprising:

a finger body extending along a longitudinal axis between an inner end of the finger body configured to be mounted on the finger drive arrangement and an outer end of the finger body configured to protrude from the outer peripheral wall of the roller through a respective one of the finger guide holes in the extended position;

the finger body comprising a cylindrical outer wall surrounding a hollow interior, spanning a length of the finger body between the inner end and the outer end thereof; and

a wear-resistant coating applied to an outer surface of the cylindrical outer wall, the finger body being formed of a first material comprising a rigid metal and the wear-resistant coating being formed of a second material having a hardness which is greater than a hardness of the first material.

Use of a hollow finger is desirable to reduce the mass of the fingers and reduce overall inertial loading on the finger drive system. This is particularly advantageous when operating the roller at high speeds. Although the inertial loading on the finger drive arrangement can be reduced by reducing the mass of the fingers, the reduced mass of material forming the finger can be susceptible to wear damage that undesirably reduces the resistance of the finger to bending. In the event that a breakaway region is provided, the wear damage which reduces the wall thickness of the hollow retractable fingers reduces the reliability of breakage occurring at the breakaway region. The resistance to undesirable bending of a hollow tube retractable finger can be advantageously improved however when the hollow finger is provided with a wear resistance coating of a material which is harder than the material forming the hollow finger body.

The finger body with the coating thereon preferably has a hardness of 55 to 75 HRC, and more preferably has a hardness of approximately 65 HRC.

The coating spans over the breakaway region in some embodiments, or alternatively in other embodiment the coating extends over only a working range of the finger between the breakaway region and the outer end of finger which passes through the outer peripheral wall of the roller.

The finger body underlying the coating may have a hardness of 35 to 65 HRC, for example by heat treating to achieve the desired hardness.

The finger body underlying the coating has a hardness of approximately 50 HRC.

An outer surface of the cylindrical outer wall preferably has an arithmetical mean roughness of 40 to 120 Ra, and more preferably an arithmetical mean roughness of approximately 60 Ra.

A radial thickness of the cylindrical outer wall between an outer surface and the hollow interior of the finger body is preferably 0.040 to 0.120 inches, and more preferably approximately 0.08 inches.

A diameter of the cylindrical outer wall of the finger body in this instance is preferably 0.50 to 0.875 inches, and more preferably approximately 0.625 inches.

### BRIEF DESCRIPTION OF THE DRAWINGS

Some embodiments of the invention will now be described in conjunction with the accompanying drawings in which:

FIG. 1 is a plan view showing the combine feeder house and central section of a header.

FIG. 2 is a section view through the centerline of the header and feeder house in the normal forward operating position showing the relationship between the feed chain, the auger and the feed draper with the fingers shown in the position where they can engage crop fed off the feed draper, convey it to the rear and release it so that the feeder house feed chain can feed the crop material into the combine.

FIG. 3 is a perspective view of the crop feeding auger shown separated from the header.

FIG. 4 is a sectional view of the crop feeding auger showing a portion of the finger drive arrangement which extends and retracts the fingers relative to the peripheral roller wall of the crop feeding auger.

FIG. 5 is a perspective view of one of the fingers.

FIG. 6 is a sectional view along the line 6-6 of FIG. 4 according to a first embodiment of the slots of the breakaway region.

FIG. 7 is a sectional view along the line 6-6 of FIG. 4 according to a second embodiment of the slots of the breakaway region.

In the drawings like characters of reference indicate corresponding parts in the different Figures.

### DETAILED DESCRIPTION

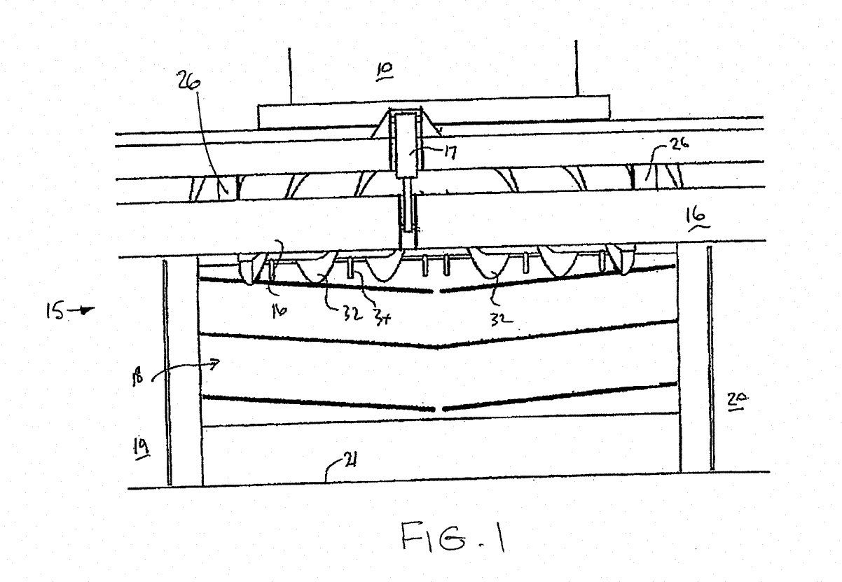

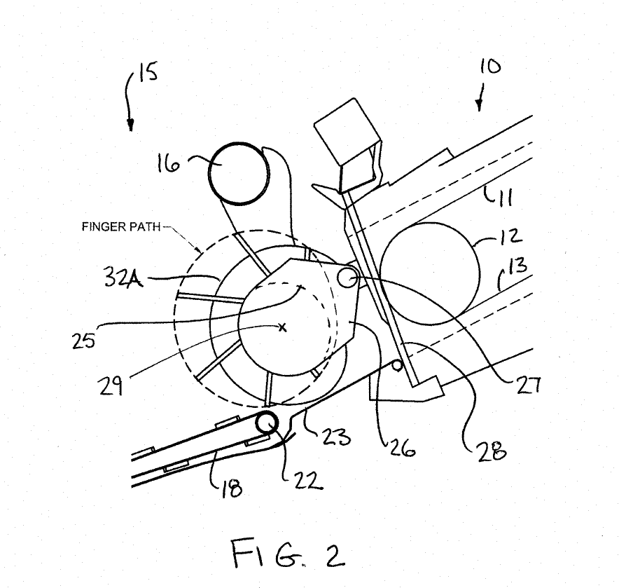

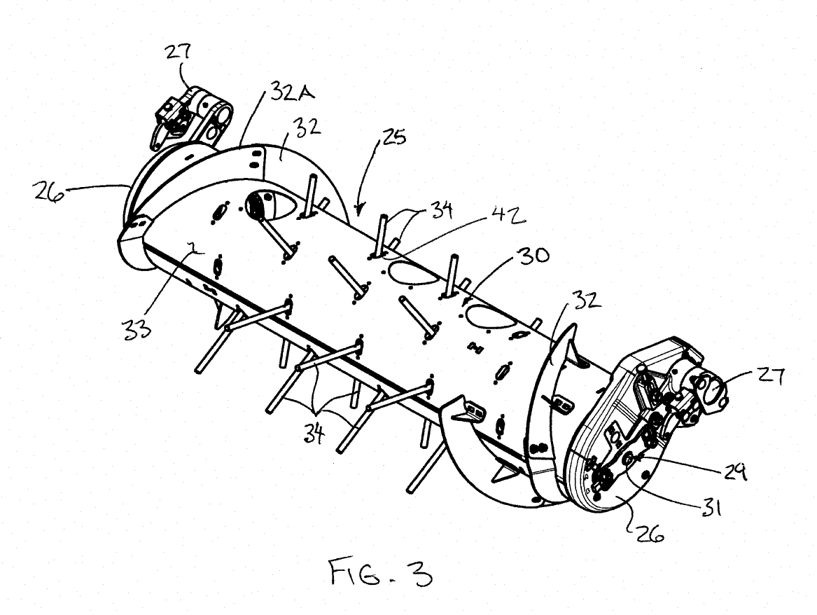

In FIGS. 1 and 2 is shown an arrangement of header and feeder house 10 for a combine harvester of the type generally shown in U.S. Pat. No. 6,675,568 issued Jan. 13, 2004 of the present assignee, the disclosure of which is incorporated herein by reference. This shows one example of an arrangement in which the invention can be used, but many other locations for the use of a feed roller of this type are well known to a person skilled in the art.

Details of the main construction of the header are omitted since these are well known to one skilled in the art and are available from the above patent document. The present arrangement is concerned primarily with the construction of the retractable fingers for use in a feed roller. Although one example of the feed roller is described herein, other feed roller arrangements may vary in accordance with the requirements of a person skilled in the art.

The arrangement as shown comprises a feeder house 10 having a feeder chain 11 mounted within the feeder house for rotation of the feeder chain around a drive sprocket 12 so that crop material is carried underneath the bottom run 13 of the feeder chain along the bottom surface of the feeder house to the operating components of the combine harvester (which are not shown).

At the forward end of the feeder house is mounted a header construction 15 which is carried on a main frame 16 in the form of a tube which is attached to the forward end of the feeder house by a link 17. Bottom links which support the header are not shown as again these are well known to one skilled in the art.

The header further includes a feed draper 18 which carries the crop rearwardly from two side drapers 19 and 20 behind a cutting knife 21 at the forward end of the header. The feed draper 18 is engaged around a roller 22 at the rear of the feed draper and in front of the feeder house and its chain 11. A pan 23 bridges the area between the rear of the draper 18 and the front of the feeder house so as to carry the material rearwardly.

A feed roller 25 is provided which assists the transfer of the crop material from the rear of the feed draper 18 into the feeder house and also applies a top compression to the crop material so as to hold it downwardly and assist in feeding the crop material under the feeder chain. Thus, the roller 25 extends across the width of the feeder house 10 as shown in FIG. 1 and slightly beyond the outside edges of the feeder house to a length so as to be located just within the extent of the feed draper 18 and between the side drapers 19 and 20. The roller 25 is carried on a pair of arms 26 one at each end each of which is pivotal about a pivot pin 27 carried on an adaptor frame 28 attached to the front of the feeder house. Thus, the axis 29 of the roller can raise and lower pivoting about the axis of the pin 27 to accommodate more or less crop passing underneath the roller and over the pan 23.

The roller 25 is supported on the pair of support arms 26 by a pair of stub-shafts 31 which are mounted at fixed locations on the two support arms 26 respectively in alignment along the roller access at opposing ends of the roller. The roller 25 includes a roller wall 30 which is cylindrical and which is mounted on respective end walls which are generally circular in shape about the roller axis at the opposing ends of the cylindrical roller wall 30. The interior of the roller defined by the roller wall 30 is open between the end walls so that the interior of the roller has no support at the axis 29 of the shafts 31.

On the outside surface of the roller is provided an auger flight 32 which is arranged helically around the wall 30 and its outer surface 33 so as to project outwardly therefrom. The auger flight, as is well known, is arranged in two sections coiled in opposite directions so as to tend to carry the crop inwardly toward the center of the feeder house as the roller rotates in a feeding or counter clockwise direction as shown in FIG. 2.

In addition, the roller carries fingers 34 at angularly and axially spaced positions around the peripheral surface 33 of the roller. In the embodiment shown there are eight angularly spaced positions of the fingers and eighteen axially spaced positions of the fingers; however, these numbers may vary in accordance with requirements.

The fingers rotate with the roller 25 but are driven by a finger drive arrangement described in more detail hereinafter so that they move radially of the axis of the roller as the roller angularly advances. As shown in FIG. 2 one of the fingers at the front side of the roller provides a maximum extension of the fingers beyond the surface 33 so that the finger projects beyond an outside edge 32A of the flight. This maximum extension position is generally at or just above the nine o'clock position in FIG. 2 or immediately at the front of the roller facing the crop. This position may be slightly angularly advanced or slightly angularly retarded as required so that the most extended position is forwardly of the axis of the roller when the arms 26 are in a lowered position so that the roller is closest to the pan 23.

Symmetrically the most retracted position of the fingers is located directly behind the roller. Thus, the normal operation of the roller and the fingers carried thereby is that the fingers extend to their maximum extension in front of the rollers so as to grasp the crop in front of the roller and tending to pile in front of the roller and to push that crop downwardly and to carry it rearwardly in a feeding action over the pan 23 to the feeder house. Behind the roller each finger gradually retracts to the most retracted position at the rear of the roller such that the outer end of the finger is substantially flush with the surface 33 so as to ensure that the crop is released at this position and is not carried by the finger in a wrapping action around the remainder of the roller.

The roller 25 has an outer peripheral wall 33 of the roller which rotates as described above and contains a plurality of finger units 40 mounted within the roller 25, each supporting a single finger or a diametrically opposed pair of fingers for movement together relative to respective finger guide holes 42 at respective locations in the roller wall 30 of the roller for alignment with the respective finger. Each finger guide hole includes a tubular bushing 44 formed of plastic material which is received therein such that the finger extends through and is slidable in a respective one of the holes in the roller so as to be movable along its length from a retracted position in which an end of the finger is adjacent the peripheral wall to an extended position on the finger path. An opening in the bushing 44 that receives the finger therein is elongated in a circumferential direction about the roller axis 29. The width in the axial direction closely matches a diameter of the finger to provide lateral support to the finger in the axial direction of the roller, but the length in the circumferential direction is greater than the diameter of the finger to allow for a change in angle of the finger relative to the wall of the roller throughout the extension and retraction of the finger.

Turning now to the drive arrangement for the fingers of the roller, a drive member 50, typically an elongate shaft, is supported within the roller for carrying the finger units 40 thereon to displace the fingers between the extended and retracted position thereof as the roller is rotated about the roller axis and the drive member is rotated about its own respective drive member axis which is parallel and radially spaced forwardly of the roller axis.

A mounting arrangement is provided for supporting the drive member 50 rotatably within the roller, in which the mounting arrangement is mainly comprised of two offset holders mounted in fixed relation onto the inner ends of the two stub shafts 31 respectively, internally within the roller. Opposing ends of the drive member 50 are rotatably received within respective ones of the offset holders. Various means are known in the art for driving rotation of the drive member 50 about its respective axis together with rotation of the feed roller about the roller axis.

The drive member 50 supports the finger units 40 thereon in which each finger unit includes a finger journals 52 pivotally supported on the drive member 50 for rotation of the finger unit relative to the drive member about a respective finger rotation axis 63 which is parallel to the axis of rotation of the drive member. The finger journal 52 rotatably supports one of the finger units 40 thereon such that the finger unit is rotatable about the respective finger rotation axis as the drive member is rotated about the drive member axis and the roller is rotated about the roller axis in operation.

Each finger unit has a hub 54 rotatably supported on the finger journal 52 of the drive member using bearings supported internally within the hub. A socket 56 protrudes radially outward from the hub 54 for receiving the inner end of the respective finger of the finger unit therein in a mounted position. A suitable screw or transverse retainer pin may extend diametrically through both the inner end of the finger and the surrounding socket 56 to selectively retain the finger within the socket of the finger unit.

Turning now more particularly to the structure of each finger, each finger 34 is elongate and tubular having a hollow interior spanning a full length along a longitudinal axis of the finger from an inner end 60 to an outer end 62 of the finger. The inner end of the finger is received within the socket 56 of a respective finger unit 40 of the finger drive arrangement. The opposing outer end of the finger protrudes from the outer peripheral wall of the roller through a respective one of the finger guide holes in the extended position.

Each finger 34 is defined by a finger body comprising a cylindrical outer wall 70 which surrounds the hollow interior of the finger along the full length thereof between the inner and outer ends. The cylindrical outer wall has an outer surface defining a constant outer diameter of the finger along the length thereof. In the preferred embodiment the outer diameter of the finger is 0.625 inches, however a diameter in the range of 0.50 to 0.875 inches is feasible, while a diameter in the range of 0.55 to 0.70 inches is more preferred. The radial thickness of the outer wall 70 according to the preferred embodiment is 0.083 inches, however a thickness in the range of 0.04 to 0.12 inches is feasible, while a thickness in the range of 0.06 to 0.1 inches is more preferred.

Each finger includes a breakaway region 72 which is located at an intermediate location along the length of the finger between the inner end and the outer end of the finger. The breakaway region is closer to the inner end so as to remain proximate to the inner end in the mounted position, while being sufficiently spaced outwardly from the inner end that the breakaway region is spaced outwardly from the socket 56 of the respective finger unit 40 supporting the finger on the finger drive arrangement. In this manner, the structure which mounts the inner end of the finger onto the finger drive arrangement does not interfere with the effectiveness of the breakaway region.

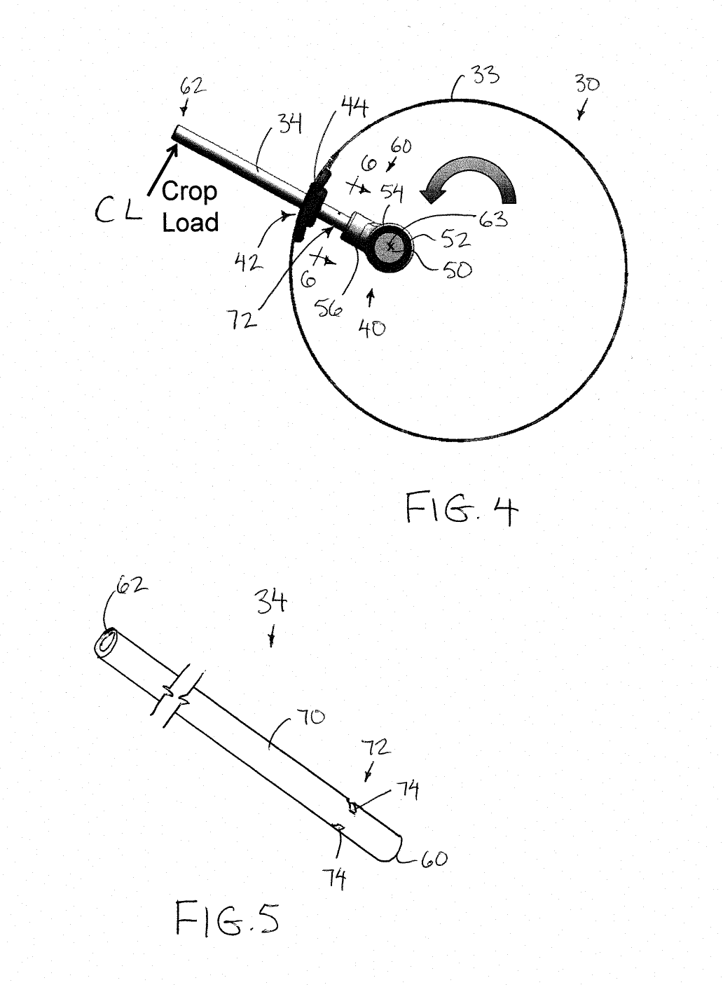

More particularly the breakaway region is located such that when the finger is fully extended as shown in FIG. 4, the breakaway region remains fully within the interior of the roller, so as to be spaced radially inwardly in relation to the bushing 44 and the peripheral wall 33 of the roller. In the illustrated embodiment, the breakaway region is located approximately 2.5 inches along the long axis of the finger radially outwardly from the axis of rotation of the finger while remaining spaced inwardly by approximately 1 inch from bushing 44 mounted in the peripheral wall 33 of the roller.

The breakaway region 72 consists of two diametrically opposed slots 74 formed in the outer wall 70 of the finger at the breakaway region. Each slot comprises a groove which is elongated in the circumferential direction about part of the circumference of the outer wall 70. Each slot in the preferred embodiment extends through an arc of approximately 60 to 100 degrees about the outer circumference of the outer wall 70 of the finger, and more preferably through a centerline arc of approximately 66 degrees. The centerline arc is defined the distance measured in the circumferential direction about a longitudinal axis of the finger body at a location which is radially centered between the inner and outer surfaces of the tubular body. The centerline arc lies along a circumference defined by the mean diameter, when the mean diameter is defined as average between the inner and outer diameters. The slot preferable extends through a centerline arc within a range of approximately 60 to 100 degrees when the end walls are normal to the outer surface according to FIG. 7.

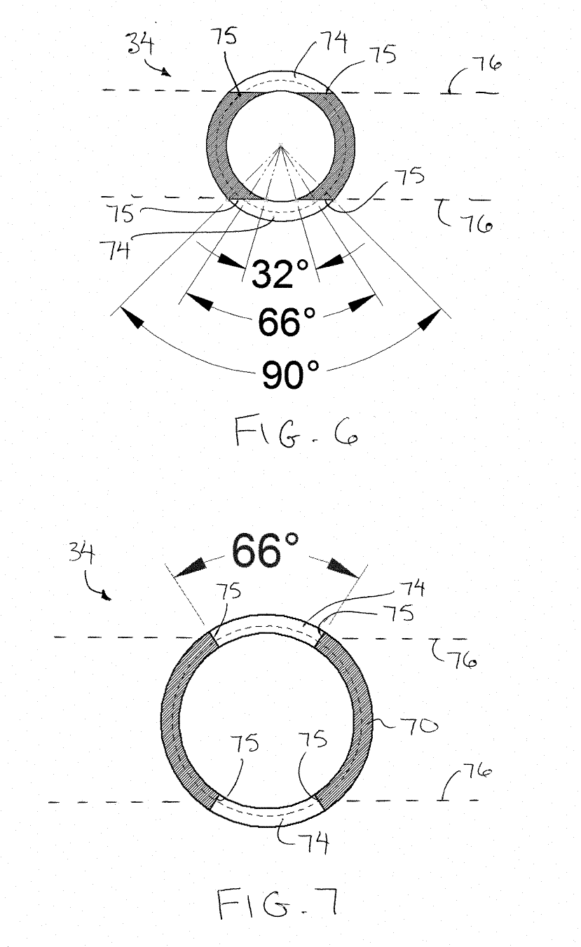

When machining the slots 74, the opposing end surfaces 75 of the slot which span the wall thickness of the tube may lie in a common plane with one another as shown in FIG. 6. In this instance, when the slot extends circumferentially through an arc of 90 degrees at the outer circumference or outer surface of the finger body, the slot may extend through a much smaller arc at the inner circumference or inner surface, for example 32 degrees as shown in FIG. 6.

In alternative embodiments, the slots may be formed with opposing end surfaces 75 which are normal to the outer surface of the finger body, for example as shown in FIG. 7 when the fingers are manufactured with a tube laser. In this instance, the slots span the same arc at the inner and outer surfaces of the finger body, for example 66 degrees according to the embodiment of FIG. 7.

In yet further embodiments, the slot end surfaces 75 may be formed with a radius (not shown) between the inner and outer surfaces of the tubular finger body.

The depth of the groove is greater than a thickness of the outer wall 70 such that each slot defines an opening extending fully through the outer wall along the length of the slot in open communication with the hollow interior of the finger. The resulting openings are also elongated in the circumferential direction about the longitudinal axis of the finger.

The slots are oriented such that an imaginary line 76 connected between opposing ends of each slot lies parallel to the roller axis. Furthermore, both imaginary lines 76 lie in a common plane which is perpendicular to the longitudinal axis of the finger.

Each slot is bound along axially opposing edges by a pair of side surfaces which span circumferentially across the length of the slot and which span radially the thickness of the wall of the finger body between inner and outer surfaces of the tubular finger body. These side surfaces are parallel to one another and perpendicular to the longitudinal axis of the finger body.

The initial steps of manufacturing the finger include providing an elongate tube formed of a steel alloy having a suitable diameter and wall thickness, and then cutting the tube to the length of a corresponding finger. The two slots 70 for forming the breakaway region 72 are then formed into the tube at the desired location, for example by machining or using a tube laser.

Either before or subsequent to forming of the slots, the finger body is heat-treated to a certain hardness, for example using a normal quench and temper process or using an Austempering process. This improves the toughness and results in decreased warpage compared to conventional heat treatment processes. In the preferred embodiment, the finger body is heat-treated to a hardness of 50 HRC, however a hardness in the range of 35 to 65 HRC is feasible, and a hardness in the range of 45 to 55 HRC is more preferable.

Before or subsequent to heat treating, the outer surface of the outer wall 70 may be further processed to produce a surface roughness which minimizes friction between the finger and the surrounding plastic bushing 44. In a preferred embodiment, an arithmetical mean roughness of the outer surface of the wall 70 is 60 Ra, however, a roughness in the range of 40 to 120 Ra is feasible, and a roughness in the range of 80 to 100 Ra is more preferable.

A wear-resistant coating is then applied to the outer surface of the wall 70 of the finger. In the preferred embodiment, the coating of the surface is accomplished by a hardening the finger through means of hard chrome plating. Other processes which achieve similar hardening of the surface can be used, for example such as Gas Nitriding, Electroless Nickel plating, Electroless Nickel Boron, or other processes which can achieve similar hardening results. The resulting coating on the outer surface of the finger body in the preferred embodiment has a hardness of approximately 65 HRC, however a hardness in the range of 55 to 75 HRC is feasible, and a hardness in the range of 60 to 70 HRC is more preferable.

The resulting thickness of the coating is such that the surface texture or roughness of the finger body prior to coating is preserved on the resulting outer surface of the coating. The surface roughness minimizes the surface contact between the outer surface of the finger and the plastic bushing of the finger guide holes to minimize friction and build-up of heat on the plastic bushings as the fingers are reciprocated in use. An ideal thickness of the coating in the instance of hard chrome plating is in the range of 0.0015 to 0.0025 inches.

The coating is typically applied to the outer surface of the finger along the full length of the finger so as to span over the breakaway region, however, in further embodiments the coating may be applied only to a working range along the length of the finger between the breakaway region and the outer end of the finger, corresponding to the portion of the finger surrounded by the bushing throughout the entire range of movement of the finger between the extended and retracted positions thereof.

When using a hollow finger as described herein, the inertial loading of the fingers upon the finger drive arrangement as a result of the angular acceleration and deceleration of each finger throughout the rotation of the feed roller is minimized. The design and location of the breakaway region provides reliable breakage of the hollow finger when loading the fingers in a circumferential direction about the roller axis in use by a crop load CL which exceeds a prescribed threshold for the finger. The additional heat treatment and coating applied to the finger body ensures that the fingers maintain strength and resist wear to resist undesirable bending of the fingers when encountering loads below a prescribed threshold for the finger throughout a service life of the finger.

Since various modifications can be made in my invention as herein above described, and many apparently widely different embodiments of same made, it is intended that all matter contained in the accompanying specification shall be interpreted as illustrative only and not in a limiting sense.

1. A retractable finger for a crop feeding apparatus having a rotatable roller, a plurality of finger guide holes in an outer peripheral wall of the roller and a finger drive arrangement supported within the roller to support the finger thereon and drive the finger as the roller rotates about a longitudinal axis of the roller to be movable along a length of the finger from an extended position in which the finger protrudes from the peripheral wall of the roller and a retracted position in which the finger is retracted inwardly of the outer peripheral wall relative to the extended position, the retractable finger comprising:
a finger body extending along a longitudinal axis between an inner end of the finger body configured to be mounted on the finger drive arrangement and an outer end of the finger body configured to protrude from the outer peripheral wall of the roller through a respective one of the finger guide holes in the extended position; and
a breakaway region formed in the finger body in proximity to the inner end at an intermediate location between the inner end and the outer end of the finger body;
the finger body comprising a cylindrical outer wall surrounding a hollow interior, spanning a length of the finger body between the inner end and the outer end thereof; and
the breakaway region comprising a pair of slots formed in the cylindrical outer wall of the finger body at diametrically opposing locations relative to one another, each slot being elongated in a circumferential direction about the finger body.

2. The retractable finger according to claim 1 wherein each slot is oriented such that an imaginary line connected between circumferentially opposing ends of the slot lies parallel to said imaginary line of the other slot.

3. The retractable finger according to claim 2 wherein said imaginary line of each slot lies parallel to the longitudinal axis of the roller.

4. The retractable finger according to claim 1 wherein the slots lie in a common plane oriented perpendicularly to the longitudinal axis of the finger body.

5. The retractable finger according to claim 1 wherein each slot extends fully through the cylindrical outer wall such that each slot defines an opening through the cylindrical outer wall which is elongated in the circumferential direction about the finger body.

6. The retractable finger according to claim 1 further comprising a wear-resistant coating applied to an outer surface of the cylindrical outer wall, the finger body being formed of a first material comprising a rigid metal and the wear-resistant coating being formed of a second material having a hardness which is greater than a hardness of the first material.

7. The retractable finger according to claim 6 wherein the finger body with the coating thereon has a hardness of 55 to 75 HRC.

8. The retractable finger according to claim 6 wherein the coating spans over the breakaway region.

9. The retractable finger according to claim 6 wherein the coating extends over a working range of the finger between the breakaway region and the outer end of finger which passes through the outer peripheral wall of the roller.

10. The retractable finger according to claim 6 wherein the finger body underlying the coating has a hardness of 35 to 65 HRC.

11. (canceled)

12. The retractable finger according to claim 1 wherein an outer surface of the cylindrical outer wall has an arithmetical mean roughness in a range of 40 to 120 Ra.

13. The retractable finger according to claim 1 wherein a radial thickness of the cylindrical outer wall between an outer surface and the hollow interior of the finger body is in a range of 0.040 to 0.120 inches.

14. The retractable finger according to claim 1 wherein a diameter of the cylindrical outer wall of the finger body is in a range of 0.50 to 0.875 inches.

15. A retractable finger for a crop feeding apparatus having a rotatable roller, a plurality of finger guide holes in an outer peripheral wall of the roller and a finger drive arrangement supported within the roller to support the finger thereon and drive the finger as the roller rotates about a longitudinal axis of the roller to be movable along a length of the finger from an extended position in which the finger protrudes from the peripheral wall of the roller and a retracted position in which the finger is retracted inwardly of the outer peripheral wall relative to the extended position, the retractable finger comprising:
a finger body extending along a longitudinal axis between an inner end of the finger body configured to be mounted on the finger drive arrangement and an outer end of the finger body configured to protrude from the outer peripheral wall of the roller through a respective one of the finger guide holes in the extended position;
the finger body comprising a cylindrical outer wall surrounding a hollow interior, spanning a length of the finger body between the inner end and the outer end thereof; and
a wear-resistant coating applied to an outer surface of the cylindrical outer wall, the finger body being formed of a first material comprising a rigid metal and the wear-resistant coating being formed of a second material having a hardness which is greater than a hardness of the first material.

16. The retractable finger according to claim 15 wherein the finger body with the coating thereon has a hardness of 55 to 75 HRC.

17. The retractable finger according to claim 16 wherein the finger body with the coating thereon has a hardness of approximately 65 HRC.

18. The retractable finger according to claim 15 wherein the coating spans over the breakaway region.

19. The retractable finger according to claim 15 wherein the coating extends over a working range of the finger between the breakaway region and the outer end of finger which passes through the outer peripheral wall of the roller.

20. (canceled)

21. The retractable finger according to claim 15 wherein the finger body underlying the coating comprises steel which has been heat treated to a hardness of 35 to 65 HRC.

22. The retractable finger according to claim 21 wherein the finger body underlying the coating has a hardness of approximately 50 HRC.

23. The retractable finger according to claim 15 wherein an outer surface of the cylindrical outer wall has an arithmetical mean roughness of 40 to 120 Ra.

24. The retractable finger according to claim 23 wherein an outer surface of the cylindrical outer wall has an arithmetical mean roughness of approximately 60 Ra.

25. (canceled)

26. (canceled)

27. (canceled)

28. (canceled)

29. A method of forming a retractable finger for a crop feeding apparatus having a rotatable roller, a plurality of finger guide holes in an outer peripheral wall of the roller and a finger drive arrangement supported within the roller to support the finger thereon and drive the finger as the roller rotates about a longitudinal axis of the roller to be movable along a length of the finger from an extended position in which the finger protrudes from the peripheral wall of the roller and a retracted position in which the finger is retracted inwardly of the outer peripheral wall relative to the extended position, the method comprising:
providing a tubular finger body formed of a cylindrical outer wall surrounding a hollow interior, spanning a length of the finger body between an inner end of the finger body configured to be mounted on the finger drive arrangement and an outer end of the finger body configured to protrude from the outer peripheral wall of the roller through a respective one of the finger guide holes in the extended position; and
applying a wear-resistant coating to an outer surface of the cylindrical outer wall, the finger body being formed of a first material comprising a rigid metal and the wear-resistant coating being formed of a second material having a hardness which is greater than a hardness of the first material.

30. The method according to claim 29 including providing an outer surface of the cylindrical outer wall with an arithmetical mean roughness of 40 to 120 Ra.

31. (canceled)

32. The method according to claim 29 including hardening the first material of the finger body by heat treating such that the finger body has a hardness of 35 to 65 HRC prior to application of the coating.

33. (canceled)

34. The method according to claim 29 including applying the coating such that the coating has a hardness of 55 to 75 HRC.

35. (canceled)
